(19) United States
(12) Patent Application Publication
(10) Pub. No.: US 2011/0139740 A1
(43) Pub. Date: Jun. 16, 2011

(54) FEEDING BOTTLES

(76) Inventor: Nouri E. Hakim, Monroe, LA (US)

(21) Appl. No.: 12/668,849

(22) PCT Filed: Jul. 14, 2008
(86) PCT No.: PCT/US08/08590

§ 371 Date: Mar. 1, 2011

Related U.S. Application Data
(60) Provisional application No. 60/959,475, filed on Jul. 13, 2007.

(51) Int. Cl. A61J 9/04

(52) U.S. Cl. 215/11.5

(57) ABSTRACT

A feeding bottle for infants includes a hollow flexible body that defines an internal volume for holding liquids. A neck is positioned at an upper portion of the body and is adapted for receiving a sealing ring and a nipple thereon. The neck is more rigid than said body. A flexible bottom encloses a lower portion of the body and a lower portion of the feeding bottle defines a plurality of vents therethrough. Each vent defines an opening therethrough operable to allow airflow into the liquid retaining internal volume while preventing leakage of liquid from the internal volume.

### RELATED APPLICATIONS

This application claims the benefit of U.S. Provisional Patent Application Ser. No. 60/959,475, filed Jul. 13, 2007, which is fully incorporated herein by reference.

### FIELD OF THE INVENTION

The present invention relates to baby products, and more particularly to vented feeding bottles for infants.

### BACKGROUND OF THE INVENTION

Throughout history, babies have fed at their mother's breast. However, bottle feeding of babies and infants became very popular in the twentieth century with the advent of the use of formula to feed babies. Baby feeding bottles, then as now, typically comprised a bottle having a high height-to-width ratio. The bottle has an open mouth over which a resilient nipple is placed. The nipple is sealed against the bottle mouth by a threaded ring. There can also be a cap to cover the nipple to prevent the nipple from being contaminated by dirt and to prevent the seepage of milk or formula from the holes in the nipple.

One problem that has long been present in bottle feeding systems is that air must be vented into the bottle to equalize pressure with the ambient outside atmosphere and thereby permit the flow of formula or milk through the teat and into the infant's mouth. In a rigid-walled bottle, air must often pass through the opening of the nipple to permit this equalization as the volume of milk or formula inside the bottle is decreased during consumption by the infant. The flow of air from outside the bottle through the nipple to equalize the pressure often results in the infant ingesting a portion of that air while nursing and thereby potentially causing the infant to suffer discomfort and colic.

One attempt at solving the problem was the use of flexible liners held within a rigid shell simulating a bottle. In this manner as the volume of liquid inside the liner decreased the liner correspondingly collapsed, thus permitting the constant flow of fluid through the nipple without a concurrent flow of air into the liner through the nipple. However, the liners are difficult to retain in the shell and can slip out causing unwanted spills. Further, the thin film liners can easily incur a hole therein and thus leak.

Vented bottles work by allowing air to enter the bottle while the infant is drinking and concurrently preventing the liquid inside from escaping through the vents. One type of venting system works by an anti-vacuum skirt in the base of the nipple where it forms a seal with the bottle. The skirt acts as a one way valve, allowing air to enter the bottle but prevents liquids from leaking out. If the sealing ring is tightened too much, the skirt is compressed too tightly to allow it to open whereupon the bottle will not vent. If the sealing ring is too loose, liquid leads from the bottle. Another attempt at venting the bottle calls for a complex spring and valve system that is impossible to clean and sterilize. Other attempts include specialized materials having microscopic pores allowing the entry of air without the escape of liquids. This alleviates the problem of over-tightening or under-tightening the sealing ring, however the capability of these materials to maintain their one way porosity after repeated cleaning and sterilization is unproven. Yet another attempt to vent an infant's feeding bottle involves a system whereby the vented air is conducted through a tube to the bottom of the bottle where the airspace is when the bottle is in use. This avoids the vented air from bubbling through the liquid and unnecessarily aerating the liquid.

### SUMMARY OF THE INVENTION

The present invention is directed to a feeding bottle for infants that satisfies the need for a vented bottle that avoids aerating the liquid within the bottle during the time the infant is nursing. The feeding bottle for infants includes a hollow flexible body that defines an internal volume for holding liquids. A neck is positioned at an upper portion of the body and is preferably more rigid than said body (whether due to molding of said neck using a more rigid material or due to placement of a rigid neck ring on a flexible material neck to form a rigid neck). The neck is adapted for receiving a sealing ring and a nipple thereon (the sealing ring and nipple forming a cap). A flexible bottom encloses a lower portion of the body and a lower portion of the feeding bottle defines a plurality of vents therethrough. Each vent defines an opening therethrough operable to allow airflow into the liquid retaining internal volume while preventing leakage of liquid from the internal volume.

Another aspect of the present invention is a feeding bottle for infants comprising a hollow flexible body that defines a liquid retaining internal volume. A flexible neck is positioned at an upper portion of the body. The neck is integrally molded with a harder material overlay, or is adapted for receiving a rigid neck ring affixed or upon the flexible neck, with a sealing ring and a nipple being attached to the neck ring. A flexible bottom encloses a lower portion of the body wherein a lower portion of the feeding bottle defines a plurality of vents therethrough. Each vent defines an opening therethrough that is operable to allow airflow into the internal volume while preventing leakage of liquid out of the internal volume.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the accompanying drawings in which:

FIG. 1 is a front elevation view of a feeding bottle embodying the present invention;

FIG. 2 is a plan view of the bottom of the feeding bottle of FIG. 1;

FIG. 3 is a cross-sectional view of the bottle shown in FIG. 1 and taken along the line 3-3, FIG. 2;

FIG. 4 is an enlarged cross-sectional elevation view of the vents formed as part of the bottom of the bottle of area 4, FIG. 3;

FIG. 5 is a top view of the vents in the bottom of the bottle shown in a closed, sealed mode and taken along the line 5-5, FIG. 4;

FIG. 6 is a top view of the vents of FIG. 5 shown in an open, venting mode.

Like reference numerals refer to like parts throughout the several views of the drawings.

### DETAILED DESCRIPTION OF THE INVENTION AND THE PREFERRED EMBODIMENTS

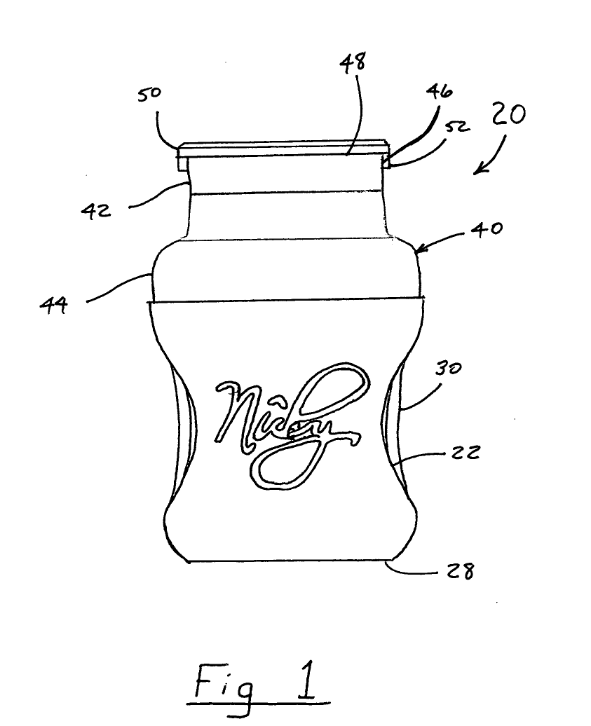

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Turning to the drawings, FIG. 1 shows a feeding bottle 20 for infants which is one of the preferred embodiments of the present invention and illustrates its various components.

As illustrated in FIGS. 1-6, feeding bottle 20 has a hollow flexible body 22 defining an internal volume 24 that is capable of retaining liquids such as milk or formula therein. Body 22 has a neck 26 at an upper end thereof and a bottom 28 enclosing a lower portion of the body. In one embodiment, body 22, neck 26 and bottom 28 are formed of a resilient and flexible material which can be sufficiently flexed or squeezed such that internal volume 24 is reduced when pressure is applied to body 22. Further preferably, the material from which bottle 20 is formed is soft or comfortable to the touch. Accordingly, in a preferred embodiment, the body 22, neck 26 and bottom 28 are made of silicone. Yet further preferably, the silicone is between 30 to 90 thousandths of an inch in thickness. However, any desired material and thickness can be used so long as they are consistent with the parameters of the invention described herein, such as the desired flexibility of the body 22 of bottle 20. Body 22 can also include depressions 30 which facilitate the grasping of bottle 20 by an infant nursing or drinking therefrom. As a further aid to grasping bottle 20 by an infant, body 22 can have mid-body portion 32 that is of smaller diameter than the upper and lower portions of body 22 thus providing body 22 with an hourglass configuration.

In a preferred embodiment, body 22 and bottom 28 are both flexible, i.e. the bottle is flexible along its entire length up to neck 26. In this preferred embodiment, neck 26 is rigid or semi-rigid such that it cannot be reduced in diameter by ordinary squeezing. The rigidity of neck 26 facilitates the attachment of a screw cap, sealing ring and nipple, or spout thereto. Nipples for use with bottle 20 can be any prior art or standard nipple, or the various nipples of the present inventor disclosed in U.S. Pat. No. 6,241,110 which is fully incorporated herein by reference. In further preferred embodiments, a no-spill valve or nipple can alternatively or additionally be screwed onto the neck, including such valves and nipples as disclosed in U.S. Pat. Nos. 6,321,931; 6,357,620; 6,994,225; 7,204,386; and 7,243,814; all of which are fully incorporated herein by reference. In alternate embodiments, a top having a straw can be screwed on neck 26.

In a further preferred embodiment, body 22, neck 26, and bottom 28 are made of the flexible material such that neck 26 is approximately of equal flexibility as body 22. In one such embodiment, a rigid neck ring 40 is affixed on neck 26 of bottle 20. A neck portion 42 of neck ring 40 has an upper edge 48 that abuts a bottom surface of rim 50 of neck 26. A skirt portion 44 can extend downwardly over and encasing an upper portion of body 22. Rigid neck ring 40 reinforces and increases the rigidity of neck 26 sufficiently to allow the cap and nipple to be affixed thereto. Rigid neck ring 40 can be constructed of plastic, such as polycarbonate or polypropylene, or of another desired rigid material. Rim 50 of neck 26 can have a finger 52 extending downwardly therefrom which in turn is engaged in a notch 46 of rigid neck ring 40. The engagement of finger 52 in notch 46 aligns flexible body 22 with rigid neck ring 40, and prevents rotation of neck ring 40 with respect to body 22. When the cap and its nipple or spout are place on bottle 20, depressions 30 and the contours that the infant or child holds are oriented in the proper position with respect to the position of the spout or nipple and with respect to the brand name on bottle 20. In an alternate embodiment, the neck ring 40 is constructed of a rigid material, to which the silicone is molded (or vice versa). In such manner, the body of the bottle is a single part having a flexible silicone portion and a rigid neck portion molded thereto. Accordingly, in the various embodiments, the bottle can be a two part bottle (with soft silicone and a separate rigid neck piece that slides onto the silicone bottle), or a one part bottle (with a soft silicone portion and a rigid neck portion that are molded together). The rigid neck can be made of nylon or any other suitable material.

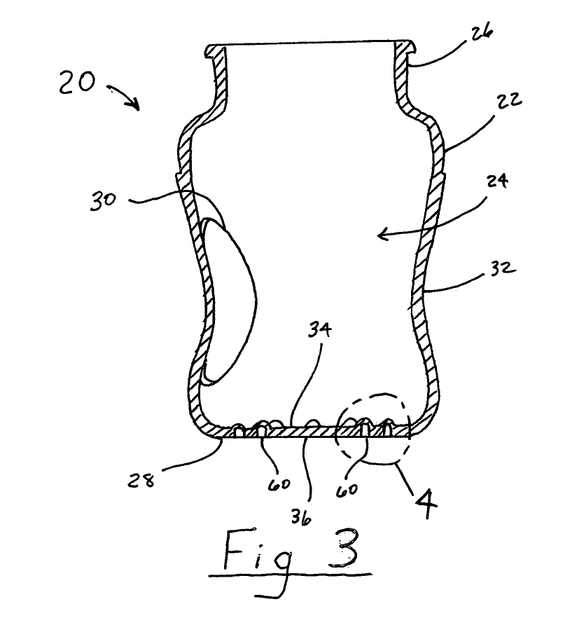

Bottom 28 has both an inner surface 34 and an outer surface 36. Geometrically, bottom 28 can adopt multiple configurations. In a preferred embodiment, inner surface 34 of bottom 28 is dome-shaped or convex while outer surface 36 is also dome-shaped correspondingly to inner surface 34. For example, in such embodiment, inner surface 34 and outer surface 34 may be substantially parallel to each other. Alternatively, outer surface 36 can be flat as illustrated in FIG. 3. Further alternatively, inner surface 34 can be flat and outer surface 36 can be correspondingly flat (substantially parallel to surface 34) or can be domed.

As illustrated in FIG. 4, bottom 28 can have a plurality of protrusions or bumps 38 extending downwardly from outer surface 36. Bumps 38 function to support bottle 20 when bottle 20 is resting on a surface such as a table or counter.

As illustrated in FIG. 3 and further illustrated in FIGS. 4-6, bottle 20 includes a plurality of integrally formed vents 60 in bottom 28. While vents 60 are shown as being formed in bottom 28, those practiced in the art will readily recognize that vents 60 can also be formed in body 22 in addition to or in lieu of vents 60 formed in bottom 28. Each vent 60 is an aperture 66 defined by bottom 28 or body 22 and covered by an integrally formed or molded membrane 64. Membrane 64 is preferably a portion of the body of the bottle (and further preferably a portion of the bottom surface of the body), which portion has been suitably thinned and/or shaped to allow it to flex in response to a decrease in pressure within the bottle caused by the drinking of the baby. Alternatively, in less preferred embodiment, membrane 64 can be a separate material from the body. In either embodiment, membrane 64 is preferably part of or located on inner surface 34 of bottom 28 or an inner surface of the body. Apertures 66 can be of any desired volume and shape. In preferred embodiments, they are either circular holes or elongated channels. In one embodiment, the channels are cylindrical. In a preferred embodiment, the elongated channels are finger shaped and have a greater diameter at their base than at their peaks, as shown in FIG. 4.

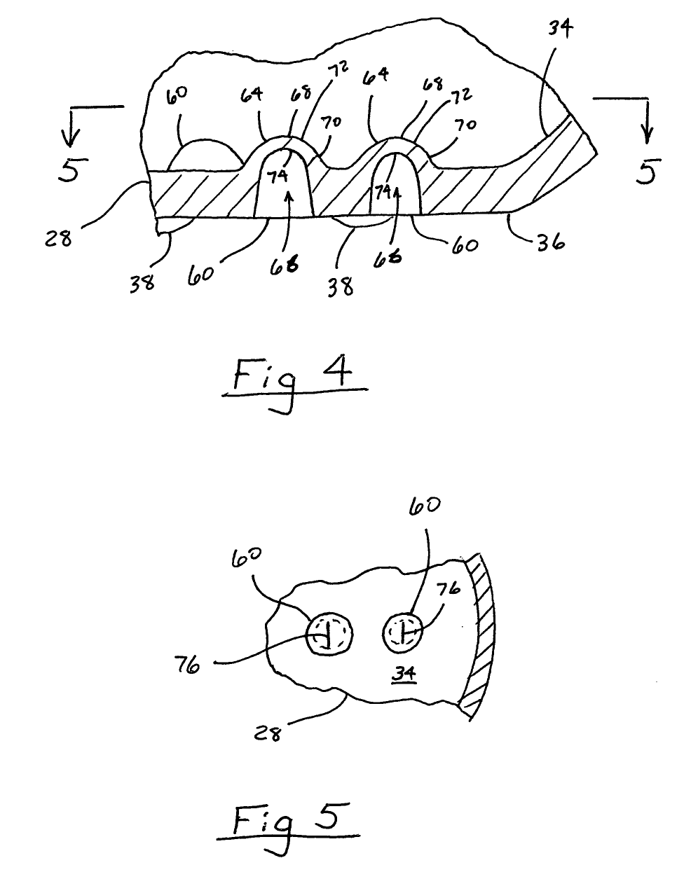

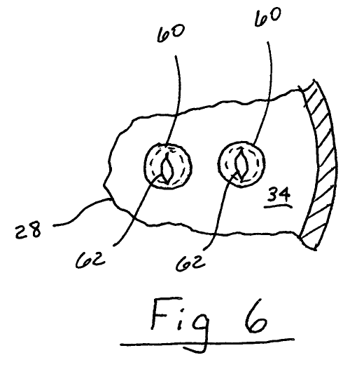

Membranes 64 are typically much thinner than the thickness of bottom 28 and can be either of uniform thickness or of non-uniform thickness. A typical non-uniform thickness membrane 64 as illustrated in FIG. 4 has a center portion 68 that is thinner than an outer periphery 70 that adjoins to bottom 28. While membranes 64 can be flat, in a most preferred embodiment, membranes 64 protrude into internal volume 24 from inner bottom surface 34. Each membrane 64 has an opening 62 therethrough. In preferred embodiments, opening 62 is a pin hole through central portion 68 or a slit 76 (FIG. 5). Slit 76 is preferably situated along the top of membrane 64, and can be of any length desired. For example, slit 76 can be situated along the center portion 68 only. Or, slit 76 can extend from one outer peripheral area 70 of membrane 64, along the top of the membrane, to the opposite outer peripheral area 70 of the membrane. Membrane 60 is preferably domed or convex on both its top and bottom surfaces 72, 74 respectively (FIG. 4).

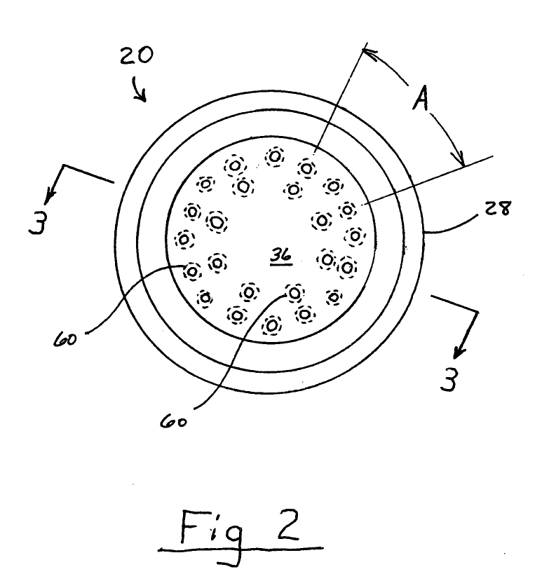

Vents 60 can be arranged in any number of configurations. In a preferred embodiment, vents 60 are equally distributed around a periphery of body 22 or regularly distributed across bottom 28. In that embodiment, a plurality of vents 60 are arranged in a regular circular pattern on bottom 28, as shown in FIG. 2. Single vent holes begin at a twelve o'clock position and are arranged every 45 degrees. Equally spaced between the single vents 60 are radially aligned double vent holes also space every 45 degrees (illustrated as angle A, FIG. 2). Alternate patterns are also permissible, such as a single ring of vent holes, or a single vent hole, or a plurality of vent holes in any other desired relative position.

In use, openings 62 in membranes 64 rest in a closed position. When liquid or pressure is introduced into internal volume 24, the pressure on the domed shape of membranes 64 forces openings 62 closed, effectively sealing vents 60 and preventing leakage of the liquid therethrough. When the infant tilts the bottle back and sucks liquid from bottle 20, the air pressure in internal volume 24 within bottle 20 decreases and becomes less than the ambient pressure external to bottle 20. This tilting and/or pressure differential causes openings 62 of vents 60 to open, allowing passage of air therethrough to equalize pressure within internal volume 24 with the ambient external to bottle 20. In this manner, air is introduced into internal volume 24 other than through the nipple or spout on which the child is sucking, thereby minimizing the ingestion of air by the child during feeding. Furthermore, in the present flexible-walled bottle 20, the surfaces of body 22 and bottom 28 move inwardly to the center of bottle 20 as the child draws liquid from internal volume 24, significantly reducing any such air intake through the nipple or spout. Accordingly, vents 60 of bottle 20 allow passage of air to provide for pressure equalization and reduction of colic and discomfort to the child. Further discussion of bottom venting is also provided, for example, in U.S. Pat. No. 5,499,729 issued to Greenwood, and U.S. Pat. No. 6,138,710 issued to Chomik et al., both of which are fully incorporated herein by reference.

The present invention provides numerous advantages over the Greenwood and Chomik products, which are embodied, in whole or in part, in a commercially available products from Playtex having a hard bottle and a removable end cap. For example, if those products are boiled too long while sterilizing its contents, or if the consumer forgets the product in the pot and the water boils out, the bottom of the product can melt or warp. In contrast, the silicone of the preferred embodiment of the present invention will not remelt, and thus could be placed directly on a very hot metal surface (such as the inner surface of a heated pot), without concern of melting or warping, unlike the Playtex product.

Likewise, the bottles of most commercial products (which are made of plastics, such as polypropylene or polycarbonate or so forth) will become hot to the touch upon boiling. In contrast, the silicone of the present invention's preferred embodiment is an insulator. Accordingly, the surface of the bottle remains cool to the touch even after the bottle is heated to sterilize or warm its contents.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

I claim:

1. An article of manufacture, comprising:
a feeding bottle for infants;
said feeding bottle comprising a hollow body defining an internal volume, said hollow body comprising an upper portion and a lower portion;
said feeding bottle comprising a neck at said upper portion of said body, said neck being adapted for receiving a sealing ring and a nipple thereon;
wherein said hollow body of said feeding bottle is constructed of a flexible material;
wherein said lower portion of said flexible body comprises at least one vent;
and wherein said vent in said flexible body comprises an opening;
such that said vent is operable to allow airflow into said internal volume;
and such that said vent prevents leakage of liquid out from said internal volume.

2. The feeding bottle according to claim 1 wherein said body is sufficiently flexible such that said body deforms in a manner to substantially reduce said internal volume when said body is squeezed by a person.

3. The feeding bottle according to claim 1 wherein at least said body is molded of silicone having a thickness between thirty and ninety thousandths inch.

4. The feeding bottle according to claim 1 wherein said body includes depressions on opposing sides thereof to facilitate an infant to grip said body.

5. The feeding bottle according to claim 1 wherein said body has an hourglass shape.

6. The feeding bottle according to claim 1 wherein said neck is threaded to accept thereon a threaded sealing ring.

7. The feeding bottle according to claim 1 wherein an inside surface of said bottom is dome-shaped.

8. The feeding bottle according to claim 7 wherein an outer surface of said bottom is dome shaped.

9. The feeding bottle according to claim 1 wherein said body of said bottle comprises at least one vent, said vent comprising a membrane, said opening being located in said membrane, said membrane further covering an aperture defined by said body.

10. The feeding bottle according to claim 9 wherein said membrane is provided as part of the bottom surface of said body.

11. The feeding bottle according to any of claims 9-10 wherein said opening is a slit.

12. The feeding bottle according to any of claims 9-11 wherein said opening is a hole.

13. The feeding bottle according to any of claims 9-12 wherein said membrane protrudes into said internal volume.

14. The feeding bottle according to any of claims 9-13 wherein said membrane is dome shaped.

15. The feeding bottle according to any of claims 9-14 wherein a thickness of said membrane is non-uniform.

16. The feeding bottle according to any of claims 9-15 wherein said thickness of said membrane is thinner at a center thereof and thicker at an outer periphery thereof.

17. The feeding bottle according to any of claims 9-16 wherein said aperture is a circular hole.

18. The feeding bottle according to any of claims 9-17 wherein said aperture is an elongate channel.

19. The feeding bottle according to any of claims 9-18 wherein said bottle comprises a plurality of said vents, and wherein said vents are positioned about a periphery of said body at regular intervals.

20. The feeding bottle according to claim 19 wherein said vents are regularly distributed across said bottom.

21. The feeding bottle according to any of claims 1-20, wherein said neck is more rigid than said body.

22. The feeding bottle according to any of claims 1-21, wherein said neck comprises a flexible neck with a rigid neck ring placed thereon, such that said neck with said neck ring thereon is more rigid than said body.

23. An article of manufacture, comprising:
a feeding bottle for infants;
said feeding bottle comprising a hollow body defining an internal volume, said hollow body comprising an upper portion and a lower portion;
said feeding bottle comprising a neck at said upper portion of said body, said neck being adapted for receiving a sealing ring and a nipple thereon;
wherein said hollow body of said feeding bottle is constructed of a flexible material;
wherein said lower portion of said body comprises at least one vent;
wherein said vent comprises a dome shaped membrane protruding into said internal volume of said feeding bottle;
and wherein said dome shaped membrane of said vent comprises an opening, and an aperture beneath said opening;
such that said vent is operable to allow airflow into said internal volume;
and such that said vent prevents leakage of liquid out from said internal volume.

24. The feeding bottle according to claims 23, wherein said neck is more rigid than said body.

25. The feeding bottle according to claims 23, wherein said neck comprises a flexible neck with a rigid neck ring placed thereon, such that said neck with said neck ring thereon is more rigid than said body.

26. The feeding bottle according to claim 25 wherein said neck ring extends downwardly encasing at least a portion of said flexible body.

27. The feeding bottle according to claim 25 wherein said neck includes an upper rim abutting an upper edge of said rigid neck ring and further includes a finger extending downwardly from said rim, said finger engaging a notch defined in said upper edge of said rigid neck ring to prevent rotation of said rigid neck ring with respect to said body.

28. The feeding bottle according to claim 23 wherein said opening is a slit.

29. The feeding bottle according to claim 23 wherein said opening is a hole.

30. The feeding bottle according to claim 23 wherein a thickness of said membrane is non-uniform.

31. The feeding bottle according to claim 23 wherein said thickness of said membrane is thinner at a center thereof and thicker at an outer periphery thereof.

32. The feeding bottle according to claim 23 wherein said aperture is a circular hole.

33. The feeding bottle according to claim 23 wherein said aperture is an elongate channel.

34. The feeding bottle according to claim 23 wherein said feeding bottle comprises a plurality of said vents, and wherein said vents are positioned about a periphery of said body at regular intervals.

35. The feeding bottle according to claim 34 wherein said vents are regularly distributed across said bottom.

36. The feeding bottle according to any of claims 23-35 wherein said body is sufficiently flexible such that said body deforms in a manner to substantially reduce said internal volume when said body is squeezed by a person.

37. The feeding bottle according to any of claims 23-36 wherein at least said body is molded of silicone having a thickness between thirty and ninety thousandths inch.

38. The feeding bottle according to according to any of claims 23-37 wherein said body includes depressions on opposing sides thereof to facilitate an infant to grip said body.

39. The feeding bottle according to any of claims 23-38 wherein said body has an hourglass shape.
